(19) United States
(12) Patent Application Publication
(10) Pub. No.: US 2025/0026214 A1
(43) Pub. Date: Jan. 23, 2025

(54) CHARGING GUN RETURNING CONTROL METHOD AND DEVICE FOR CHARGING PILE, CHARGING PILE, AND MEDIUM

(71) Applicant: Autel Digital Power Co., Ltd., Shenzhen (CN)

(72) Inventors: Yong CHEN, Shenzhen (CN); Yunfeng XU, Shenzhen (CN)

(73) Assignee: Autel Digital Power Co., Ltd., Shenzhen (CN)

(21) Appl. No.: 18/907,587

(22) Filed: Oct. 6, 2024

Related U.S. Application Data
(63) Continuation of application No. PCT/CN2023/077954, filed on Feb. 23, 2023.

(30) Foreign Application Priority Data
Apr. 6, 2022 (CN) 202210359421.8

(51) Int. Cl. B60L 53/16; B60L 53/60; H02J 7/00

(52) U.S. Cl. CPC B60L 53/16; B60L 53/60; H02J 7/00712

(57) ABSTRACT

Embodiments of the present disclosure relate to the field of charging piles, and disclose a charging gun returning control method and device for a charging pile, a charging pile, and a medium, wherein the method includes: acquiring a signal intensity change generated between a charging gun and a gun seat when the charging pile is in a non-charging state; determining that a current operation is a gun unplugging operation when it is detected that the signal intensity change is less than a gun unplugging change threshold; and determining that the current operation is a gun plugging operation when it is detected that the signal intensity change is greater than a gun plugging change threshold; where the gun unplugging change threshold and the gun plugging change threshold are mutually opposite numbers.

### CROSS-REFERENCE TO RELATED APPLICATIONS

This application is a continuation application of International Patent Application No. PCT/CN2023/077954 filed on Feb. 23, 2023, which claims priority to Chinese Patent Application No. 202210359421.8, filed on Apr. 6, 2022, the entire disclosures of both of which are incorporated herein by reference for all purposes.

### TECHNICAL FIELD

The present disclosure relates to the technical field of charging piles, and more particularly, to a charging gun returning control method and device for a charging pile, a charging pile, and a medium.

### BACKGROUND

Conventional charging gun returning detection for a charging pile relies on threshold detection, specific decision about a gun plugging state is achieved by deciding a detection threshold of a detection sensor disposed on a gun seat of the charging pile, for example, ultrasonic charging gun returning detection is to complete charging gun returning detection by detecting the intensity of an ultrasonic signal reflected by a gun head through an infrared signal sensor on the gun seat, when the intensity is greater than a preset value, it is considered that the charging gun is plugged back into a socket; and when the intensity is less than a preset threshold, it is considered that the charging gun is not plugged into the socket.

It is found that when the threshold detection for charging gun returning operation is adopted, due to aging of detection module components of the charging gun and the charging pile, differences in installation environments and other reasons, structure changes lead to relatively large differences between actual detected values and standard thresholds, and often lead to abnormal decision, so that the accuracy of charging gun returning detection is affected, and the user experience is also affected and the after-sales cost is increased.

### SUMMARY

An object of embodiments of the present disclosure is to provide a charging gun returning control method for a charging pile, a charging pile, and a medium which may accurately decide charging gun returning operation for a charging gun by a user.

In order to solve at least the above technical problem, the embodiments of the present disclosure adopt the following technical solutions:

In a first aspect, the present disclosure provides a charging gun returning control method for a charging pile, applied to the charging pile provided with a gun seat and connected to a charging gun; the method includes: acquiring a signal intensity change generated between the charging gun and the gun seat when the charging pile is in a non-charging state; determining that a current operation is a gun unplugging operation when it is detected that the signal intensity change is less than a gun unplugging change threshold; and determining that the current operation is a gun plugging operation when it is detected that the signal intensity change is greater than a gun plugging change threshold; where the gun unplugging change threshold and the gun plugging change threshold are mutually opposite numbers.

In a second aspect, the present disclosure further provides a charging gun returning control device for a charging pile, applied to the charging pile, the device includes: an acquirer configured for acquiring a signal intensity change generated between a charging gun and a gun seat when the charging pile is in a non-charging state; a gun unplugging determiner configured for determining that current operation is gun unplugging operation when it is detected that the signal intensity change is less than a gun unplugging change threshold; and a gun plugging determiner configured for determining that the current operation is gun plugging operation when it is detected that the signal intensity change is greater than a gun plugging change threshold; where the gun unplugging change threshold and the gun plugging change threshold are mutually opposite numbers.

In a third aspect, the present disclosure further provides a charging pile, including: at least one processor, and a memory communicatively connected to the at least one processor, the memory storing instructions executable by the at least one processor, and the instructions being executed by the at least one processor to cause the at least one processor to execute the method according to the first aspect.

In a fourth aspect, the present disclosure further provides a non-transitory computer-readable storage medium, storing computer-executable instructions which, when executed by a charging pile, cause the charging pile to execute the method according to any one of the first aspects.

### BRIEF DESCRIPTION OF DRAWINGS

One or more embodiments are exemplarily illustrated with reference to drawings in the corresponding accompanying drawings. These exemplary illustrations do not constitute a limitation on the embodiments, elements having the same reference numerals in the accompanying drawings represent similar elements, and the drawings in the accompanying drawings do not constitute a limitation on scales, unless otherwise specified.

FIG. 1 is an interaction diagram of a charging pile and a charging gun according to an embodiment of the present disclosure.

FIG. 2 is a schematic flow diagram of a charging gun returning control method for a charging pile according to an embodiment of the present disclosure.

FIG. 3 is an interaction diagram of a charging pile with a charging gun and an upper computer according to an embodiment of the present disclosure.

FIG. 4 is a schematic structural diagram of a charging gun returning control device for a charging pile according to an embodiment of the present disclosure.

FIG. 5 is a schematic diagram showing a hardware structure of a controller in a charging pile according to an embodiment of the present disclosure.

### DETAILED DESCRIPTION

The present disclosure is described in detail below in conjunction with specific embodiments. The following embodiments will aid those skilled in the art in further understanding the present disclosure, but do not limit the present disclosure in any way. It should be noted that several variations and modifications may be made by those ordinarily skilled in the art without departing from the inventive concepts herein. These are all within the scope of protection of the present disclosure.

In order to make the objects, technical solutions and advantages of the present disclosure clearer, the present disclosure is further explained in detail below in conjunction with accompanying drawings and embodiments. It should be understood that the specific embodiments described herein are illustrative only and are not restrictive of the present disclosure.

It should be noted that various features in the embodiments of the present disclosure may be combined with each other without conflict within the scope of protection of the present disclosure. In addition, although functional module partitioning is performed in a schematic diagram of a device, and a logical order is shown in a flowchart, in some cases, the steps shown or described may be executed by module partitioning other than that in the device, or in an order other than that in the flowchart. In addition, the words “first,” “second,” “third,” and the like, as adopted herein do not limit the order of data and execution, but merely distinguish between identical or similar items with substantially the same function and effect.

Unless defined otherwise, all technical and scientific terms used in this description have the same meaning as commonly understood by those skilled in the art to which the present disclosure belongs. In this description, the terms used in the description of the present disclosure are for the purpose of describing particular embodiments only and are not intended to limit the present disclosure. As used herein, the term “and/or” includes any and all combinations of one or more related listed items.

In addition, the technical features involved in various embodiments of the present disclosure described below may be combined with each other as long as they do not conflict with each other.

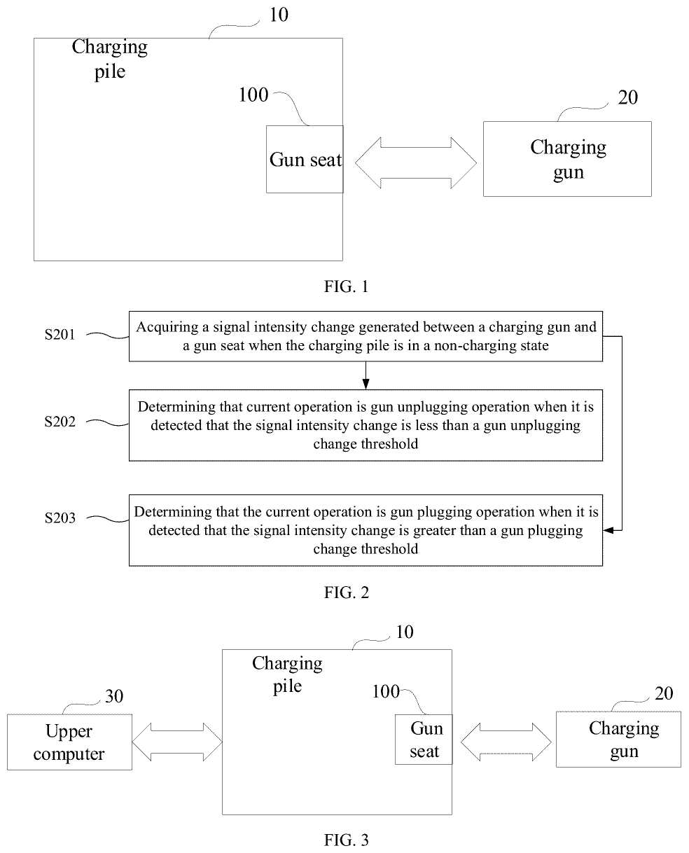

A charging gun returning control method and device for a charging pile provided in embodiments of the present disclosure may be applied to the charging pile, as shown in FIG. 1, the charging pile 10 includes a controller 11 and a gun seat 100, and the charging pile 10 is connected to a charging gun 20; the gun seat 100 disposed on the charging pile 10 enables the charging gun 20 to be plugged into the gun seat 100, so as to achieve charging gun returning operation by a user; the gun seat 100 is provided with a distance sensor, a gun head of the charging gun 20 is provided with an ultrasonic or infrared signal transmission module, the distance sensor on the gun seat 100 may detect a signal intensity on the gun head, and when the gun head of the charging gun 20 is closer to the gun seat, the signal intensity detected by the distance sensor is higher; and when the gun head of the charging gun 20 is farther from the gun seat, the signal intensity detected by the distance sensor is lower.

FIG. 2 is a schematic flow diagram of a charging gun returning control method for a charging pile according to an embodiment of the present disclosure. As shown in FIG. 2, the method may be executed by the controller 11 in the charging pile, and the method includes step S201 to step S203. In some examples, a charging gun may be referred to as a charging connector, a charging plug, a charging handle, a charging coupler, etc.

S201 includes acquiring a signal intensity change generated between the charging gun and the gun seat when the charging pile is in a non-charging state.

The charging pile detects that the charging gun is in the non-charging state, which may be a case where the user completes a charging order for an electric automobile by using the charging gun, a case where the charging order is not started, and a case where the user plugs the charging gun into the gun seat but does not start the charging order. It is acceptable as long as the charging pile is in the non-charging state.

When the charging pile is in the non-charging state, the charging pile detects the signal intensity change generated between the charging gun and the gun seat, and may detect the signal intensity change generated by the ultrasonic or infrared signal transmission module disposed on the gun head of the charging gun through the distance sensor on the gun seat.

In some embodiments, in order to obtain the signal intensity change, step S201 may include:
recording a first signal intensity value at a first time node;
recording a second signal intensity value at a second time node after a first preset duration from the first time node; the second time node being a sum of the first time node and the first preset duration; and
taking a difference value obtained by subtracting the first signal intensity value from the second signal intensity value as the signal intensity change.

In an embodiment, when the charging pile is in the non-charging state, the controller 11 of the charging pile detects the signal intensity value of the gun head at the first time node through the distance sensor on the gun seat, records the signal intensity value as the first signal intensity value, and records the first signal intensity value at the first time node; and then the second time node is reached after the first preset duration has passed, namely, the second time node is equal to the sum of the first time node and the first preset duration, the controller 11 of the charging pile detects the signal intensity value of the gun head at the second time node through the distance sensor on the gun seat, records the signal intensity value as the second signal intensity value, and records the second signal intensity value at the second time node, and then takes the difference value obtained by subtracting the first signal intensity value from the second signal intensity value as the signal intensity change.

For example, when the first time node is 1 s, the first signal intensity value is 20; and the first preset duration is 3 s. Therefore, when the second time node which is 4 s is reached after 3 s has passed, the second signal intensity value is 200. At this moment, the difference value obtained by subtracting the first signal intensity value from the second signal intensity value is 200−20=180, and the difference value 180 is taken as the signal intensity change.

For another example, when the first time node is 1 s, the first signal intensity value is 200; and the first preset duration is 3 s. Therefore, when the second time node which is 4 s is reached after 3 s has passed, the second signal intensity value is 20. At this moment, the difference value obtained by subtracting the first signal intensity value from the second signal intensity value is 20−200=−180, and the difference value −180 is taken as the signal intensity change.

In some of the embodiments, in order to accurately acquire the second signal intensity value, the recording a second signal intensity value at a second time node after a first preset duration from the first time node may include: acquiring a plurality of first signal sampling values in a process from the first time node to the second time node; obtaining a plurality of second signal sampling values after removing a maximum value and a minimum value in the plurality of first signal sampling values; and calculating a mean value of the plurality of second signal sampling values to obtain the second signal intensity value.

In an embodiment, in the process from the first time node to the second time node, the charging pile samples the signal intensity values collected by the distance sensor at a sampling frequency of 100 ms, for example, a sampling window is 1 s, the controller 11 of the charging pile performs uninterrupted sampling, and after each time of sampling, the mean value of signal sampling values in the sampling window is calculated as the first signal sampling value, namely, one first signal sampling value is obtained every other 1 s; then the remaining first signal sampling values after removing the maximum value and the minimum value in the plurality of first signal sampling values are recorded as the second signal sampling values; and then the mean value of the plurality of second signal sampling values is calculated to obtain the second signal intensity value.

S202 includes determining that a current operation is a gun unplugging operation when it is detected that the signal intensity change is less than a gun unplugging change threshold; and
S203 includes determining that the current operation is a gun plugging operation when it is detected that the signal intensity change is greater than a gun plugging change threshold;
where the gun unplugging change threshold and the gun plugging change threshold are mutually opposite numbers.
in an embodiment, the gun unplugging change threshold and the gun plugging change threshold are mutually opposite numbers, namely, when the gun unplugging change threshold is a negative number, the gun plugging change threshold is a positive number, for example, when the gun unplugging change threshold is −150, the gun plugging change threshold is 150.

Therefore, if the signal intensity change is a positive number, it is decided whether the signal intensity change is greater than the gun plugging change threshold, and correspondingly, if the signal intensity change is a negative number, it is decided whether the signal intensity change is less than the gun unplugging change threshold.

For example, if the signal intensity change is 180 which is a positive number, it is decided whether the signal intensity change 180 is greater than the gun plugging change threshold 150, obviously, the signal intensity change 180 is greater than the gun plugging change threshold 150, and then it is determined that the current operation is gun plugging operation.

For another example, if the signal intensity change is −180 which is a negative number, it is decided whether the signal intensity change −180 is less than the gun unplugging change threshold −150, obviously, the signal intensity change −180 is less than the gun unplugging change threshold −150, and then it is determined that the current operation is gun unplugging operation.

Accurate control of charging gun returning is achieved by accurately deciding the gun unplugging operation and the gun plugging operation.

In some of the embodiments, if the charging pile is in a charging state, decision on the gun unplugging or gun plugging operation for the charging gun is stopped.

In the embodiment of the present disclosure, when it is detected that the charging gun is in a non-charging state, the charging pile determines that the current operation is gun unplugging operation when it is detected that the signal intensity change generated between the charging gun and the gun seat is less than the gun unplugging change threshold; and determines that the current operation is gun plugging operation when it is detected that the signal intensity change is greater than the gun plugging change threshold. Moreover, as the gun unplugging change threshold and the gun plugging change threshold are mutually opposite numbers, by detecting a relationship between the signal intensity change and the gun plugging change threshold or the gun unplugging change threshold, it may be known whether the signal intensity change is a change from small to large or from large to small, and the intensity of the change is stable, so as to determine whether a gun plugging or unplugging motion is made, thereby improving the accuracy of charging gun returning detection; furthermore, as the signal intensity change is detected, when there is noise interference from the outside, the detection of the signal intensity change is not affected, so that the interference caused by background noise from the outside may be prevented.

In some embodiments, in order to obtain the gun plugging change threshold and the gun unplugging change threshold, the method further includes:
receiving a threshold determination instruction sent by an upper computer when the charging pile is in a non-charging state;
acquiring a test signal intensity change based on the threshold determination instruction when reaching a second preset duration; and
in response to determining that the test signal intensity change is greater than a threshold,
calculating the gun plugging change threshold based on a value of the test signal intensity change.
in an embodiment, when the charging pile is in a non-charging state, as shown in FIG. 3, the charging pile is connected to an upper computer 30, a user operates on the upper computer 30, so that the upper computer 30 generates a threshold determination instruction, then the upper computer 30 sends the threshold determination instruction to the charging pile 10, and the charging pile 10 receives the threshold determination instruction.

After receiving the threshold determination instruction, the charging pile collects the test signal intensity change within a period of time. The period of time is a second preset duration, and the second preset duration may be 1 minute. Within one minute, the charging pile samples signals of a detection sensor on the gun seat according to a certain frequency, and a sampling mode is similar to the above signal intensity change, so as to obtain the test signal intensity change Delta_Test.

Then, the relationship between the test signal intensity change Delta_Test and a threshold is decided, the threshold may be set in advance, and the threshold may be a signal intensity value detected during gun plugging before delivery of the charging pile and the charging gun. If the test signal intensity change Delta_Test is greater than the threshold, it is indicated that the charging pile detects a reasonable signal intensity change, and at this moment, the gun plugging change threshold is calculated based on the test signal intensity change.

Further, the calculating the gun plugging change threshold based on a value of the test signal intensity change includes:
multiplying the test signal intensity change by a constant greater than 0 and less than 1 to obtain the gun plugging change threshold.
in an embodiment, for example, if the gun plugging change threshold is represented by Delta1 and the constant is represented by k, the gun plugging change threshold Delta1=the test signal intensity change Delta_Test*k.

As a hardware difference may exist between the distance sensor on the gun seat of the charging pile and the ultrasonic or infrared signal transmission module on the gun head of the charging gun in the prior art, an error in the measured signal intensity value may be caused, for example, due to aging of hardware components, and other reasons, the actual signal intensity change is less than the measured signal intensity change at the time of delivery. Therefore, in order to prevent the signal intensity change from being too small and resulting in inaccurate charging gun returning detection, the measured signal intensity change is multiplied by a constant less than 1, so as to expand a detection range of the signal intensity change as the gun plugging change threshold, so as to improve the accuracy of decision on the gun plugging operation.

Correspondingly, after obtaining the gun plugging change threshold Delta1, as the gun plugging change threshold and the gun unplugging change threshold are mutually opposite numbers, the gun unplugging change threshold Delta2=−Delta1.

In some embodiments, after the acquiring a test signal intensity change, the method further includes: in response to determining that the test signal intensity change is less than the threshold, prompting fault information.

in an embodiment, after acquiring the test signal intensity change, if the test signal intensity change is less than the threshold, it is indicated that the user may have an error in operation, or the distance sensor on the gun seat and the ultrasonic or infrared signal transmission module on the gun head of the charging gun may fail, so that the measurement in an unreasonable state is caused, and therefore, the failure information may be prompted, the user may be prompted to operate many times, or a failure solution is found, so as to remeasure the gun plugging change threshold.

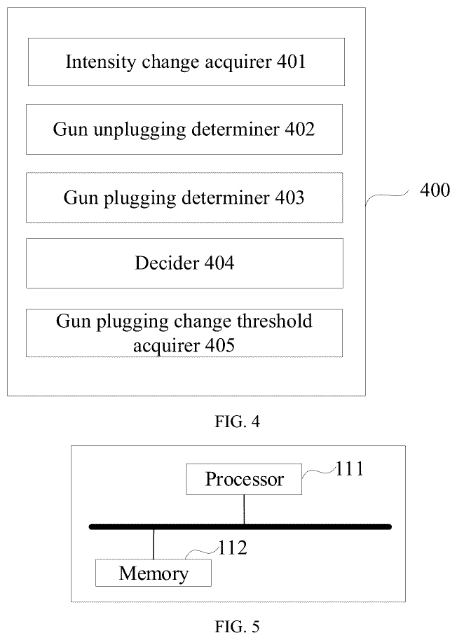

An embodiment of the present disclosure further provides a charging gun returning control device for a charging pile. FIG. 4 is a schematic structural diagram of a charging gun returning control device for a charging pile according to an embodiment of the present disclosure. As shown in FIG. 4, the charging gun returning control device 400 for the charging pile includes: an intensity change acquirer 401 configured for acquiring a signal intensity change generated between a charging gun and a gun seat when the charging pile is in a non-charging state; a gun unplugging determiner 402 configured for determining that current operation is gun unplugging operation when it is detected that the signal intensity change is less than a gun unplugging change threshold; and a gun plugging determiner 403 configured for determining that the current operation is gun plugging operation when it is detected that the signal intensity change is greater than a gun plugging change threshold; where the gun unplugging change threshold and the gun plugging change threshold are mutually opposite numbers.

In the embodiment of the present disclosure, when it is detected that the charging gun is in a non-charging state, the charging pile determines that the current operation is gun unplugging operation when it is detected that the signal intensity change generated between the charging gun and the gun seat is less than the gun unplugging change threshold; and determines that the current operation is gun plugging operation when it is detected that the signal intensity change is greater than the gun plugging change threshold. Moreover, as the gun unplugging change threshold and the gun plugging change threshold are mutually opposite numbers, by detecting a relationship between the signal intensity change and the gun plugging change threshold or the gun unplugging change threshold, it may be known whether the signal intensity change is a change from small to large or from large to small, and the intensity of the change is stable, so as to determine whether a gun plugging or unplugging motion is made, thereby improving the accuracy of charging gun returning detection; furthermore, as the signal intensity change is detected, when there is noise interference from the outside, the detection of the signal intensity change is not affected, so that the interference caused by background noise from the outside may be prevented.

In some embodiments, the intensity change acquirer 401 is further configured for: recording a first signal intensity value at a first time node; recording a second signal intensity value at a second time node after a first preset duration from the first time node; the second time node being a sum of the first time node and the first preset duration; and taking a difference value obtained by subtracting the first signal intensity value from the second signal intensity value as the signal intensity change.

In some embodiments, the intensity change acquirer 401 is further configured for: acquiring a plurality of first signal sampling values in a process from the first time node to the second time node; obtaining a plurality of second signal sampling values after removing a maximum value and a minimum value in the plurality of first signal sampling values; and calculating a mean value of the plurality of second signal sampling values to obtain the second signal intensity value.

In some embodiments, the gun unplugging change threshold is a negative number and the gun plugging change threshold is a positive number; and the charging gun returning control device 400 for the charging pile further includes a decider 404 configured for: in response to determining that the signal intensity change is a positive number, determining whether the signal intensity change is greater than the gun plugging change threshold; and in response to determining that the signal intensity change is a negative number, determining whether the signal intensity change is less than the gun unplugging change threshold.

In some embodiments, the charging gun returning control device 400 for the charging pile further includes a gun plugging change threshold acquirer 405 configured for: receiving a threshold determination instruction sent by an upper computer when the charging pile is in a non-charging state; acquiring a test signal intensity change based on the threshold determination instruction when reaching a second preset duration; and in response to determining that the test signal intensity change is greater than a threshold, calculating the gun plugging change threshold based on a value of the test signal intensity change.

In some embodiments, the gun plugging change threshold acquirer 405 is further configured for: multiplying the test signal intensity change by a constant greater than 0 and less than 1 to obtain the gun plugging change threshold.

In some embodiments, the gun plugging change threshold acquirer 405 is further configured for: in response to determining that the test signal intensity change is less than the threshold, prompting fault information.

It should be noted that the above device may execute the method provided in the embodiment of the present disclosure, and has the corresponding functional modules for executing the method and beneficial effects. Technical details which are not described in detail in the embodiment of the device may be found in the method provided in the embodiment of the present disclosure.

FIG. 5 is a schematic diagram of a hardware structure of a controller 11 in one example of the charging pile. As shown in FIG. 5, the controller 11 includes: one or more processors 111, and a memory 112. In FIG. 5, one processor 111 and one memory 112 are taken as an example.

The processor 111 and the memory 112 may be connected through a bus or in other ways, and the connection through the bus is taken as an example in FIG. 5.

The memory 112, as a computer-readable storage medium, may be configured for storing a non-volatile software program, a non-volatile computer-executable program and modules, such as program instructions/modules corresponding to the charging gun returning control method for the charging pile in the embodiment of the present disclosure (for example, the intensity change acquirer 401, the gun unplugging determiner 402, the gun plugging determiner 403, the decider 404 and the gun plugging change threshold acquirer 405 shown in FIG. 4). The processor 111 executes various functional applications of the controller 11 and data processing by running the non-volatile software programs, instructions and modules stored in the memory 112, namely, implements the charging gun returning control method for the charging pile in the embodiment of the method above.

The memory 112 may include a program storage area and a data storage area, where the program storage area may store an operating system and an application program required for at least one function; and the data storage area may store data created according to the use of the charging gun returning control device for the charging pile, and the like. In addition, the memory 112 may include a high-speed random access memory and may further include a non-volatile memory, such as at least one magnetic disk storage component, a flash memory component, or other non-volatile solid-state storage components. In some embodiments, the memory 112 optionally includes memories remotely disposed relative to the processor 111, and these remote memories may be connected to the charging pile through a network. Instances of the above network include but are not limited to, the Internet, intranets, local area networks, mobile communication networks, and combinations thereof.

The one or more modules are stored in the memory 112, and when executed by the one or more processors 111, the one or more modules execute the charging gun returning control method for the charging pile in any one of the embodiments of the method above, for example, execute step S201 to step S203 of the method in FIG. 2 described above; and implement the functions of modules 401-405 in FIG. 4.

The above product may execute the method provided in the embodiment of the present disclosure, and has the corresponding functional modules for executing the method and beneficial effects. Technical details which are not described in detail in this embodiment may be found in the method provided in the embodiment of the present disclosure.

An embodiment of the present disclosure provides a non-transitory computer-readable storage medium, the storage medium storing computer-executable instructions which, when executed by one or more processors, such as one processor 111 in FIG. 5, cause the one or more processors to execute the charging gun returning control method for the charging pile in any one of the embodiments of the method above, for example, execute step S201 to step S203 of the method in FIG. 2 described above; and implement the functions of modules 401-405 in FIG. 4.

Different from the conditions of the related art, according to the charging gun returning control method and device for a charging pile, the charging pile, and the medium provided in the embodiments of the present disclosure, when it is detected that the charging gun is in a non-charging state, the charging pile determines that the current operation is gun unplugging operation when it is detected that the signal intensity change is less than the gun unplugging change threshold; and determines that the current operation is gun plugging operation when it is detected that the signal intensity change is greater than the gun plugging change threshold. Moreover, as the gun unplugging change threshold and the gun plugging change threshold are mutually opposite numbers, by detecting a relationship between the signal intensity change and the gun plugging change threshold or the gun unplugging change threshold, it may be known whether the signal intensity change is a change from small to large or from large to small, and the intensity of the change is stable, so as to determine whether a gun plugging or unplugging motion is made, thereby improving the accuracy of charging gun returning detection; furthermore, as the signal intensity change is detected, when there is noise interference from the outside, the detection of the signal intensity change is not affected, so that the interference caused by background noise from the outside may be prevented.

The embodiments of the device described above are merely schematic, where units illustrated as separate elements may or may not be physically separated, the elements shown as units may or may not be physical units, namely, may be positioned in one place, or may also be distributed over a plurality of network units. Some or all of the modules may be selected to achieve the objects of the solution of the embodiment according to actual needs.

From the above description of the embodiments, it will be clear to those ordinarily skilled in the art that various embodiments may be implemented by means of software plus a general-purpose hardware platform, and of course may also be implemented by means of hardware. It will be understood by those ordinarily skilled in the art that implementing all or part of the flow of the method of the embodiment above may be completed by a computer program for instructing the related hardware, the program may be stored in the computer-readable storage medium, and when executed, the program may include the flow of the embodiments of various methods described above, where the storage medium may be a magnetic disk, a compact disk, a Read-Only Memory (ROM) or a Random Access Memory (RAM), and the like.

Finally, it should be noted that the above embodiments are merely illustrative of the technical solutions of the present disclosure, rather than limiting the technical solutions; under the idea of the present disclosure, the technical features in the above embodiments or different embodiments may also be combined, the steps may be implemented in any order, and there are many other changes of different aspects of the present disclosure as described above, which are not provided in the details for the sake of brevity; although the present disclosure has been described in detail with reference to the foregoing embodiments, those ordinarily skilled in the art will understand that the technical solutions disclosed in the various embodiments described above may still be modified, or some of the technical features thereof may be substituted with equivalents; however, these modifications or substitutions do not make the essence of the corresponding technical solutions depart from the scopes of the technical solutions in the various embodiments of the present disclosure.

The foregoing is only the specific embodiment of the present disclosure, but the scope of protection of the present disclosure is not limited to this, those skilled in the art may easily think of changes or substitutions within the technical scope disclosed by the present disclosure, and these changes or substitutions shall be covered by the scope of protection of the present disclosure. Therefore, the scope of protection of the present disclosure shall be subject to the scope of protection of the claims.

What is claimed is:

1. A charging gun returning control method for a charging pile, applied to the charging pile provided with a gun seat and connected to a charging gun; the method comprising:
acquiring a signal intensity change generated between the charging gun and the gun seat when the charging pile is in a non-charging state;
determining that a current operation is a gun unplugging operation when it is detected that the signal intensity change is less than a gun unplugging change threshold; and
determining that the current operation is a gun plugging operation when it is detected that the signal intensity change is greater than a gun plugging change threshold;
wherein the gun unplugging change threshold and the gun plugging change threshold are mutually opposite numbers.

2. The method according to claim 1, wherein acquiring the signal intensity change generated between the charging gun and the gun seat comprises:
recording a first signal intensity value at a first time node;
recording a second signal intensity value at a second time node after a first preset duration from the first time node, wherein the second time node is a sum of the first time node and the first preset duration; and
taking a difference value obtained by subtracting the first signal intensity value from the second signal intensity value as the signal intensity change.

3. The method according to claim 2, wherein recording the second signal intensity value at the second time node after the first preset duration from the first time node comprises:
acquiring a plurality of first signal sampling values in a process from the first time node to the second time node;
obtaining a plurality of second signal sampling values by removing a maximum value and a minimum value in the plurality of first signal sampling values; and
calculating a mean value of the plurality of second signal sampling values to obtain the second signal intensity value.

4. The method according to claim 1, wherein the gun unplugging change threshold is a negative number and the gun plugging change threshold is a positive number; and
wherein the method further comprises:
in response to determining that the signal intensity change is a positive number, determining whether the signal intensity change is greater than the gun plugging change threshold; and
in response to determining that the signal intensity change is a negative number, determining whether the signal intensity change is less than the gun unplugging change threshold.

5. The method according to claim 1, further comprising:
receiving a threshold determination instruction sent by an upper computer when the charging pile is in the non-charging state;
acquiring a test signal intensity change based on the threshold determination instruction when reaching a second preset duration; and
in response to determining that the test signal intensity change is greater than a threshold, calculating the gun plugging change threshold based on a value of the test signal intensity change.

6. The method according to claim 5, wherein calculating the gun plugging change threshold based on the value of the test signal intensity change comprises:
multiplying the test signal intensity change by a constant greater than 0 and less than 1 to obtain the gun plugging change threshold.

7. The method according to claim 5, wherein after acquiring the test signal intensity change, the method further comprises:
in response to determining that the test signal intensity change is less than the threshold, prompting fault information.

8. A charging pile, comprising:
at least one processor, and
a memory communicatively connected to the at least one processor, the memory storing instructions executable by the at least one processor, and the instructions being executed by the at least one processor to cause the at least one processor to perform acts comprising:
acquiring a signal intensity change generated between the charging gun and the gun seat when the charging pile is in a non-charging state;
determining that a current operation is a gun unplugging operation when it is detected that the signal intensity change is less than a gun unplugging change threshold; and
determining that the current operation is a gun plugging operation when it is detected that the signal intensity change is greater than a gun plugging change threshold;
wherein the gun unplugging change threshold and the gun plugging change threshold are mutually opposite numbers.

9. A non-transitory computer-readable storage medium, storing computer-executable instructions which, when executed by a charging pile, cause the charging pile to perform acts comprising:
acquiring a signal intensity change generated between the charging gun and the gun seat when the charging pile is in a non-charging state;
determining that a current operation is a gun unplugging operation when it is detected that the signal intensity change is less than a gun unplugging change threshold; and
determining that the current operation is a gun plugging operation when it is detected that the signal intensity change is greater than a gun plugging change threshold;
wherein the gun unplugging change threshold and the gun plugging change threshold are mutually opposite numbers.
